(19) United States
(12) Patent Application Publication
(10) Pub. No.: US 2018/0111096 A1
(43) Pub. Date: Apr. 26, 2018

(54) MEMBRANE SEPARATION TYPE ACTIVATED SLUDGE TREATMENT METHOD AND MEMBRANE SEPARATION TYPE ACTIVATED SLUDGE TREATMENT SYSTEM

(71) Applicant: SUMITOMO ELECTRIC INDUSTRIES, LTD., Osaka-shi, Osaka (JP)

(72) Inventors: Hiromu TANAKA, Osaka (JP); Hiroko MIKI, Osaka (JP); Tomoyuki YONEDA, Osaka (JP); Toru MORITA, Osaka (JP)

(73) Assignee: SUMITOMO ELECTRIC INDUSTRIES, LTD., Osaka-shi, Osaka (JP)

(21) Appl. No.: 15/562,948

(22) PCT Filed: Apr. 19, 2016
(86) PCT No.: PCT/JP2016/062373

§ 371 Date: Sep. 29, 2017

(30) Foreign Application Priority Data
May 7, 2015 (JP) 2015-094657

(51) Int. Cl. B01D 65/02; C02F 1/44; B01D 63/02; C02F 3/12

(52) U.S. Cl. CPC B01D 65/02; C02F 1/44; B01D 63/02; C02F 2303/16; B01D 2321/185; B01D 2317/04; C02F 3/12

(57) ABSTRACT

A membrane separation type activated sludge treatment method according to an embodiment of the present invention includes a step of performing biological treatment on waste water; and a step of performing membrane separation after the biological treatment step, wherein the membrane separation step is performed with a plurality of filtration modules including a plurality of hollow fiber membranes arranged adjacent to one another and oriented in one direction and a pair of holding members fixing both ends of the plurality of hollow fiber membranes, and a number of the filtration modules operated is changed in accordance with variations in an inflow rate of waste water in the biological treatment step.

### TECHNICAL FIELD

The present invention relates to a membrane separation type activated sludge treatment method and a membrane separation type activated sludge treatment system.

### BACKGROUND ART

The purification treatment for effluents such as industrial waste water, animal sewage, and sewage water often employs activated sludge processes, which have high treatment efficiency. In particular, a process attracting attention is a membrane separation type activated sludge process (MBR process), which performs separation between treated water and sludge not by the conventional precipitation method, but with a microfiltration membrane (MF membrane) or an ultra filtration membrane (UF membrane). Examples of a purification treatment system employing this membrane separation type activated sludge process include a system that includes an aeration tank and a membrane separation tank as separate tanks, and a one-tank system in which a filtration membrane is immersed in a reactor.

The aeration tank is a tank where a large amount of microbes grown are used to capture and consume contamination substances that are mainly organic substances in effluent, to thereby purify the effluent. Flocs of such microbes having the capability of purifying effluent are referred to as activated sludge. The aeration means supplying of air to water to thereby supply oxygen. Some microbes require oxygen to live, and, in the activated sludge process, aeration is perfoiined by supplying air to the aeration tank with a blower from the bottom portion of the aeration tank or by stirring the surface in the aeration tank.

The filtration membrane, which separates purified water (treated water) and activated sludge from each other in the aeration tank, is unavoidably subjected to fouling due to adhesion of activated sludge to the surface of the filtration membrane. For this reason, it has been proposed that activated sludge adhering to the surface of the filtration membrane is removed by supplying air bubbles from beneath the filtration membrane and scrubbing the surface of the filtration membrane with the air bubbles (for example, refer to Japanese Unexamined Patent Application Publication No. 2010-253355).

In order to suppress fouling of the filtration membrane, treated water passing through the filtration membrane needs to be controlled so as to have an appropriate flux per unit area. For this reason, the above-described publication discloses a system having a configuration in which waste water (raw water) is temporarily stored in an adjusting tank to thereby be supplied at a constant flow rate to the activated sludge tank.

### CITATION LIST

### Patent Literature

PTL 1: Japanese Unexamined Patent Application Publication No. 2010-253355

### SUMMARY OF INVENTION

A membrane separation type activated sludge treatment method according to an embodiment of the present invention includes a step of performing biological treatment on waste water; and a step of performing membrane separation after the biological treatment step, wherein the membrane separation step is performed with plural filtration modules including plural hollow fiber membranes arranged adjacent to one another and oriented in one direction and a pair of holding members fixing both ends of the plural hollow fiber membranes, and a number of the filtration modules operated is changed in accordance with variations in an inflow rate of waste water in the biological treatment step.

A membrane separation type activated sludge treatment system according to another embodiment of the present invention includes a tank configured to perform biological treatment on waste water, and an apparatus configured to perform membrane separation on water having been treated in the biological treatment tank, wherein the membrane separation apparatus includes plural filtration modules including plural hollow fiber membranes arranged adjacent to one another and oriented in one direction and a pair of holding members fixing both ends of the plural hollow fiber membranes, and the membrane separation apparatus includes a device configured to change a number of the filtration modules operated, in accordance with variations in an inflow rate of waste water in the biological treatment tank.

### BRIEF DESCRIPTION OF DRAWINGS

FIG. 1 is a schematic view illustrating the configuration of a membrane separation type activated sludge treatment system according to an embodiment of the present invention.

FIG. 2 is a schematic perspective view illustrating a filtration block including filtration modules in the membrane separation apparatus of the membrane separation type activated sludge treatment system in FIG. 1.

### DESCRIPTION OF EMBODIMENTS

### Technical Problem

In the membrane separation type activated sludge treatment system disclosed in the above-described publication, in order to achieve constant treatment of waste water, installation of an adjusting tank is necessary that has a sufficiently large capacity to buffer variations in the amount of waste water generated. However, for example, factories that are operated only in the daytime cause large variations in the amount of waste water generated; and installation of adjusting tanks that have a sufficient capacity results in a considerable increase in equipment costs, which is problematic.

Under the above-described circumstances, the present invention has been made. An object is to provide a membrane separation type activated sludge treatment method and a membrane separation type activated sludge treatment system that can address variations in the flow rate of waste water without installation of any adjusting tank.

### Advantageous Effects of Disclosure

A membrane separation type activated sludge treatment system according to an embodiment of the present invention and a membrane separation type activated sludge treatment system according to another embodiment can address variations in the flow rate of waste water without using any adjusting tank.

### Description of Embodiments of the Present Invention

A membrane separation type activated sludge treatment method according to an embodiment of the present invention includes a step of performing biological treatment on waste water; and a step of performing membrane separation after the biological treatment step, wherein the membrane separation step is performed with plural filtration modules including plural hollow fiber membranes arranged adjacent to one another and oriented in one direction and a pair of holding members fixing both ends of the plural hollow fiber membranes, and a number of the filtration modules operated is changed in accordance with variations in an inflow rate of waste water in the biological treatment step.

In the membrane separation type activated sludge treatment method, the number of the filtration modules operated is changed in accordance with variations in the inflow rate of waste water in the biological treatment step, so that, while the flux of treated water passing through the hollow fiber membranes is maintained, the rate of treated water discharged can be controlled in accordance with the inflow rate of waste water. Thus, the membrane separation type activated sludge treatment method can address variations in the flow rate of waste water without using any adjusting tank.

The plural filtration modules are preferably provided as plural filtration blocks each including filtration modules that share a suction system, and a number of the filtration blocks operated is preferably changed in accordance with variations in the inflow rate of waste water in the biological treatment step. In this way, the plural filtration modules may be provided as plural filtration blocks each including filtration modules that share a suction system, and the number of the filtration blocks operated may be changed in accordance with variations in the inflow rate of waste water in the biological treatment step, to thereby simplify the control for addressing variations in the flow rate of waste water.

The membrane separation step preferably employs plural cleaning modules supplying air bubbles from beneath the filtration modules, and, of the plural cleaning modules, only one or more cleaning modules beneath one or more filtration modules that are being operated are preferably operated. In this way, the membrane separation step may employ plural cleaning modules supplying air bubbles from beneath the filtration modules, and, of the plural cleaning modules, only one or more cleaning modules beneath one or more filtration modules that are being operated may be operated, to thereby selectively clean only one or more filtration modules that are being operated and thus subjected to an increase in the amount of activated sludge adhering to the surfaces of hollow fiber membranes. This enables a reduction in the energy consumed by the cleaning modules.

A daily minimum inflow rate of waste water in the biological treatment step is preferably equal to or higher than 0.2 times a daily average inflow rate of waste water in the biological treatment step, and a daily maximum inflow rate of waste water in the biological treatment step is preferably equal to or lower than 2 times the daily average inflow rate of waste water in the biological treatment step. In this way, when the daily minimum inflow rate of waste water in the biological treatment step is the above-described lower limit or higher and the daily maximum inflow rate of waste water in the biological treatment step is the above-described upper limit or lower, the number of the filtration modules operated does not vary excessively, which is advantageous in terms of cost, compared with the case where an adjusting tank is installed to smooth the inflow rate of waste water. Incidentally, the “daily minimum”, the “daily average”, and the “daily maximum” mean the minimum, the average, and the maximum of values measured hourly in 1 day (24 hours).

A membrane separation type activated sludge treatment system according to another embodiment of the present invention includes a tank configured to perform biological treatment on waste water, and an apparatus configured to perform membrane separation on water having been treated in the biological treatment tank, wherein the membrane separation apparatus includes plural filtration modules including plural hollow fiber membranes arranged adjacent to one another and oriented in one direction and a pair of holding members fixing both ends of the plural hollow fiber membranes, and the membrane separation apparatus includes a device configured to change a number of the filtration modules operated, in accordance with variations in an inflow rate of waste water in the biological treatment tank.

The membrane separation type activated sludge treatment system includes a device configured to change the number of the filtration modules operated, in accordance with variations in the inflow rate of waste water in the biological treatment tank, so that, while the flux of treated water passing through the hollow fiber membranes is maintained, the rate of treated water discharged can be controlled in accordance with the inflow rate of waste water. Thus, the membrane separation type activated sludge treatment system can address variations in the flow rate of waste water without using any adjusting tank.

A tank configured to adjust the inflow rate of waste water in the biological treatment tank is preferably not provided. Thus, a tank configured to adjust the inflow rate of waste water in the biological treatment tank may not be provided, which enables a reduction in the equipment costs.

### Details of Embodiments of the Present Invention

Hereinafter, a membrane separation type activated sludge treatment system according to an embodiment of the present invention will be described in detail with reference to the drawings.

### [Membrane Separation Type Activated Sludge Treatment System]

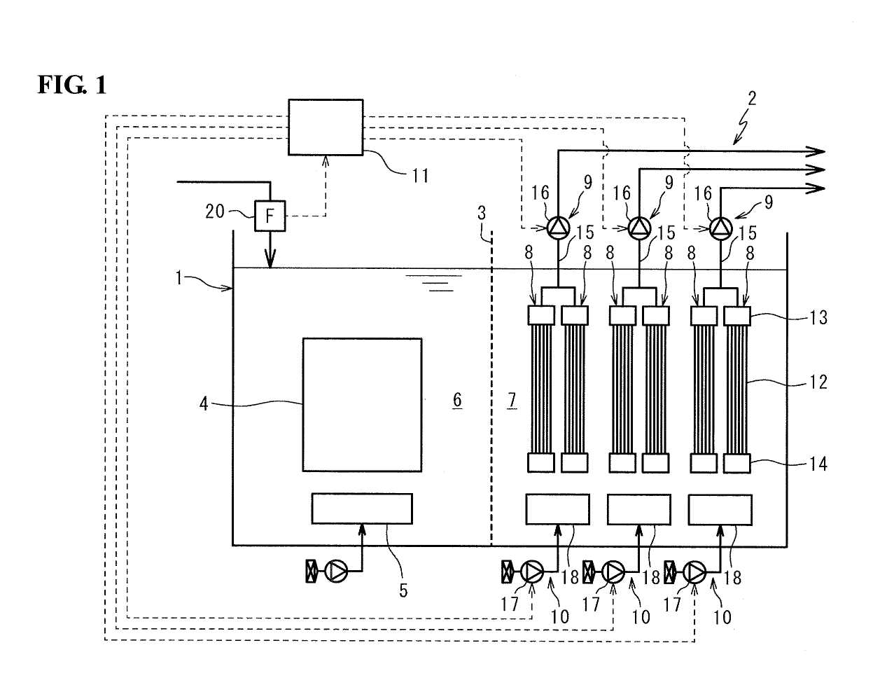

A membrane separation type activated sludge treatment system in FIG. 1 includes a biological treatment tank 1, which performs biological treatment on waste water; and a membrane separation apparatus 2, which performs membrane separation on water having been treated in the biological treatment tank 1.

The membrane separation type activated sludge treatment system does not have any adjusting tank configured to adjust the inflow rate of waste water. As a result, the membrane separation type activated sludge treatment system enables a saving in the installation space and a reduction in the installation costs.

### [Biological Treatment Tank]

The biological treatment tank 1 is a water tank storing untreated water that is a mixture of waste water newly introduced and waste water being treated. To this biological treatment tank 1, waste water flows directly from its source. Thus, the membrane separation type activated sludge treatment system does not have any tank configured to adjust the flow rate of waste water flowing into the biological treatment tank 1, which enables a reduction in the equipment costs.

The untreated water within the biological treatment tank 1 contains activated sludge (aerobic microbes). The activated sludge performs oxidative decomposition or absorptive separation on organic substances in the untreated water.

The biological treatment tank 1 includes a partition part 3 so as to be divided into a biological treatment section 6, which includes a support 4, to which activated sludge adheres at a high concentration, and aeration equipment 5, which supplies air to the lower portion of the support 4, and a separation section 7, in which the membrane separation apparatus 2 is disposed. The biological treatment section 6 and the separation section 7 communicate with each other. As described later, treated water is discharged by the membrane separation apparatus 2 from the separation section 7, which causes the untreated water to flow from the biological treatment section 6 into the separation section 7.

### (Support)

The support 4 is not particularly limited in terms of structure as long as the structure can maintain adhesion of plural flocs of activated sludge. For example, the support 4 may be a porous membrane having plural pores. The support 4 is also not particularly limited in terms of material, and the material is preferably polytetrafluoroethylene (PTFE) from the viewpoint of strength, chemical resistance, and ease of formation of pores, for example. Incidentally, a flocculant may be employed to make activated sludge adhere to the support 4.

The support 4 may be fixed in the biological treatment tank 1, or may be disposed so as to be swung or moved by the flow. The support 4 is preferably disposed such that air bubbles supplied from the aeration equipment 5 can efficiently supply oxygen to the supported activated sludge.

Incidentally, the activated sludge may be appropriately supplied, with an activated sludge addition tank and an activated sludge addition pipe (not shown), to the biological treatment tank 1 or the support 4. The membrane separation apparatus 2 may include a device that, for example, captures images to observe the number of flocs of activated sludge within the biological treatment tank 1, and automatically supplies activated sludge when the number of flocs of activated sludge becomes a lower limit or less.

The membrane separation apparatus 2 is provided such that, when the number of flocs of activated sludge within the biological treatment tank 1 becomes an upper limit or more, the activated sludge can be removed through the bottom portion of the biological treatment tank 1 or preferably through the bottom portion of the separation section 7. The membrane separation apparatus 2 may have a device that automatically performs this removal of activated sludge.

### (Aeration Equipment)

The aeration equipment 5 supplies air containing oxygen to activated sludge in the untreated water within the biological treatment tank 1, in particular, to activated sludge supported by the support 4. In other words, the aeration equipment 5 supplies oxygen to thereby promote a reduction in the amount of organic substances caused by activated sludge.

### [Membrane Separation Apparatus]

The membrane separation apparatus 2 includes plural filtration modules 8, which are configured to filter untreated water; plural discharge mechanisms 9, which are connected to the plural filtration modules 8 and suction and discharge treated water having been filtered by the filtration modules 8 (operate the filtration modules 8); at least one cleaning module 10, which supplies air bubbles from beneath the filtration modules 8; and a control device 11, which changes the number of the filtration modules 8 operated (in other words, the number of the discharge mechanisms 9 operated), in accordance with variations in the inflow rate of waste water in the biological treatment tank 1.

In the membrane separation type activated sludge treatment system, the membrane separation apparatus 2 includes the control device 11, so that, as will be described later in detail, while the filtration water rate (flux) in each filtration module 8 is maintained to be within a range, the rate of treated water discharged can be controlled in accordance with the inflow rate of waste water in the biological treatment tank 1. Thus, the membrane separation type activated sludge treatment system can address variations in the flow rate of waste water without using any adjusting tank.

### <Filtration Modules>

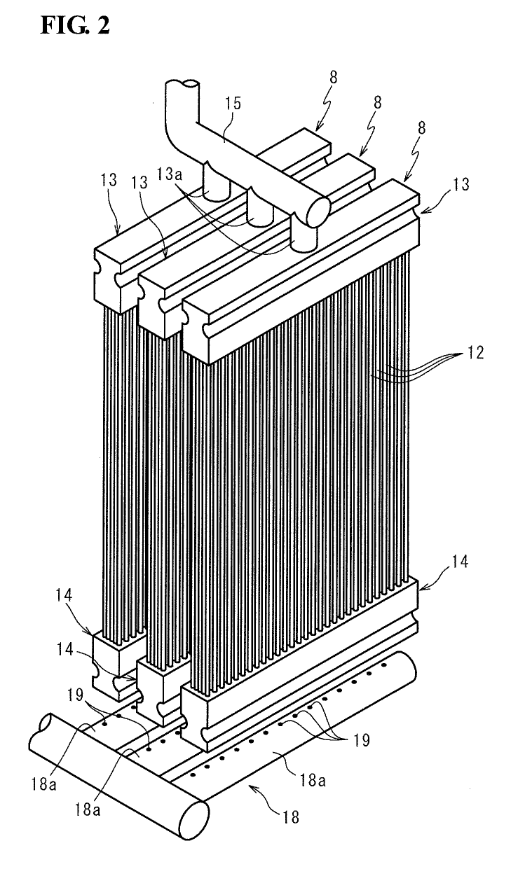

As illustrated in FIG. 2, the filtration modules 8 include plural hollow fiber membranes 12, which are arranged adjacent to one another and oriented in the upward-downward direction; an upper holding member 13, which fixes the upper ends of the plural hollow fiber membranes 12; and a lower holding member 14, which, together with the upper holding member 13, forms a pair and fixes the lower ends of the plural hollow fiber membranes 12.

In the membrane separation apparatus 2, the plural filtration modules 8 have a configuration in which the upper holding members 13 and the lower holding members 14 are formed so as to have a rod-like shape, and the plural hollow fiber membranes 12 are arranged adjacent to one another in the axial direction (longitudinal direction) of the upper holding members 13 and the lower holding members 14 so as to form a curtain-like shape. In the bundles of the hollow fiber membranes 12 arranged so as to form a curtain-like shape, air bubbles can reach, with relative ease, the central portions (in the thickness direction) of the bundles. This enables high cleaning efficiency of cleaning modules 10 described later.

In the membrane separation apparatus 2, the plural filtration modules 8 are arranged parallel to each other at regular intervals. Stated another way, in the plural filtration modules 8, the upper holding members 13 are held such that their longitudinal axes are arranged parallel to each other at regular intervals, and the lower holding members 14 are held such that their longitudinal axes are arranged parallel to each other at regular intervals.

In each filtration module 8, the upper holding member 13 and the lower holding member 14, which form a pair, are preferably held such that the distance (linear distance) between the pair is shorter than the average effective length of the hollow fiber membranes 12, so that the plural hollow fiber membranes 12 have slack. More specifically, the average effective length of the hollow fiber membranes 12 is preferably larger than the average linear distance between both ends of the effective region (linear distance between the center of the lower surface of a hollow-fiber-membrane-12-holding portion of the upper holding member 13 and the center of the upper surface of a hollow-fiber-membrane-12-holding portion of the lower holding member 14). Incidentally, the “average effective length” is the average of lengths (along the central axes) of portions of the hollow fiber membranes, the portions not being held by the holding members.

Thus, the hollow fiber membranes 12 have slack, which facilitates entry of air bubbles into the bundles of the hollow fiber membranes 12. In addition, the hollow fiber membranes 12 swing and the resultant vibrations can enhance the cleaning effect.

### (Hollow Fiber Membranes)

The hollow fiber membranes 12 are porous membranes that are permeable to water, but prevent impurities contained in untreated water from passing therethrough, and that are formed so as to have a tubular shape.

The hollow fiber membranes 12 may be formed of a thermoplastic resin as a main component. Examples of the thermoplastic resin include polyethylene, polypropylene, polyvinylidene fluoride, ethylene-vinyl alcohol copolymers, polyamide, polyimide, polyetherimide, polystyrene, polysulfone, polyvinyl alcohol, polyphenylene ether, polyphenylene sulfide, acetylcellulose, polyacrylonitrile, and polytetrafluoroethylene (PTFE). Of these, preferred is a PTFE that is porous and is excellent in terms of, for example, mechanical strength, chemical resistance, heat resistance, weather resistance, and flame resistance; more preferred is a uniaxially or biaxially expanded PTFE. Incidentally, the material for forming the hollow fiber membranes 12 may appropriately contain, for example, another polymer and additives such as a lubricant.

### (Upper Holding Members)

The upper holding members 13 each have an internal space that communicates with the lumens of the plural hollow fiber membranes 12 held by the upper holding member 13. The upper holding members 13 have a drainage nozzle 13a for discharging, from the internal space, water having been treated by filtration through the hollow fiber membranes 12.

### (Lower Holding Members)

The lower holding members 14 hold the lower ends of the hollow fiber membranes 12. The lower holding members 14 may have an internal space as in the upper holding members 13, or may hold the lower ends of the hollow fiber membranes 12 so as to block the openings of the hollow fiber membranes 12.

Incidentally, the filtration modules 8 may include a coupling member that couples the upper holding member 13 and the lower holding member 14 together in order to facilitate handling (for example, transportation, installation, and replacement). Examples of the coupling member include a support rod formed of metal and a casing (outer cylinder) formed of resin.

### <Discharge Mechanisms>

The discharge mechanisms 9 constitute suction systems that suction treated water from one or more filtration modules 8. Stated another way, the plural filtration modules 8 in the membrane separation apparatus 2 are divided into plural filtration blocks as illustrated in FIG. 2; and, for each filtration block, a discharge mechanism 9 that suctions treated water is disposed. Thus, in the membrane separation apparatus 2, the discharge mechanisms 9 can be individually operated or stopped, in other words, each filtration block including plural filtration modules 8 that share a suction system can be independently operated or stopped.

Specifically, the plural discharge mechanisms 9 are connected to the drainage nozzles 13a of the plural filtration modules 8, and each include a water collecting pipe 15 for collecting treated water provided by filtration of untreated water through the hollow fiber membranes 12, and a suction pump 16, which suctions treated water through the water collecting pipe 15.

In the membrane separation type activated sludge treatment system, the plural filtration modules 8 are provided as plural filtration blocks each including filtration modules 8 that share a suction system; and the control device 11 changes the number of the filtration blocks operated, in accordance with variations in the inflow rate of waste water in the biological treatment tank 1. Thus, in the membrane separation type activated sludge treatment system, the number of the discharge mechanisms 9 operated under control of the control device 11, that is, the number of the filtration blocks, is smaller than the number of the filtration modules 8, which enables simplification of control for addressing variations in the flow rate of waste water.

In the membrane separation type activated sludge treatment system, the lower limit of the daily minimum inflow rate of waste water in the biological treatment tank 1 is preferably 0.2 times, more preferably 0.5 times, the daily average inflow rate. On the other hand, the upper limit of the daily maximum inflow rate of waste water in the biological treatment tank 1 is preferably 2 times, more preferably 1.5 times, the daily average inflow rate. When the lower limit of the daily minimum inflow rate of waste water in the biological treatment tank 1 is less than the above-described lower limit, the number of filtration modules 8 included in each filtration block needs to be decreased and the control may become complicated, or advantages in terms of costs over the case of installing an adjusting tank may not be provided. On the other hand, when the daily maximum inflow rate of waste water in the biological treatment tank 1 is higher than the above-described upper limit, the control may also become complicated, or the number of filtration modules 8 required increases and hence advantages in terms of costs over the case of installing an adjusting tank may not be provided.

The membrane separation type activated sludge treatment system is preferably designed such that, at the time of the maximum inflow rate of waste water in the biological treatment tank 1, all the filtration modules 8 are operated and the flux at this time is an optimal flux for the hollow fiber membranes 12.

### <Cleaning Modules>

As illustrated in FIG. 1 and FIG. 2, the cleaning modules 10 are disposed beneath the plural filtration modules 8. Such a cleaning module 10 is preferably disposed for each of the filtration blocks.

The cleaning modules 10 are modules at least configured to eject air bubbles. For example, as illustrated in FIG. 1 and FIG. 2, the cleaning modules 10 may include air suppliers 17, which supply air, and plural air headers 18, which are disposed beneath the filtration modules 8; and, in each of the air headers 18, plural air bubble ejection ports 19 may be formed.

### (Air Suppliers)

Examples of the air suppliers 17 include a blower and a compressor.

### (Headers)

The air headers 18 may be constituted by, for example, pipes. More specifically, as illustrated in FIG. 2, the air headers 18 preferably include one or more pipes 18a, which are provided in a one-to-one relationship with the filtration modules 8 and extend along a presence region A of the hollow fiber membranes 12 in plan view. The air bubble ejection ports 19 may be formed in a line in each of the pipes 18a.

### (Air Bubble Ejection Ports)

The air bubble ejection ports 19 are preferably formed in a line in the longitudinal direction of the presence region A of the hollow fiber membranes 12. When the air bubble ejection ports 19 are formed in a line in the longitudinal direction of the presence region A, air bubbles released through the air bubble ejection ports 19 rise along the curtain-like bundles of the hollow fiber membranes 12 and scrub the hollow fiber membranes 12, to thereby efficiently remove suspensoids and the like adhering to the outer circumferential surfaces of the hollow fiber membranes 12.

### <Control Device>

The control device 11 controls, on the basis of incoming signals from a sensor 20, which measures the inflow rate of waste water in the biological treatment tank 1, the number of the filtration modules 8 and the cleaning modules 10 operated, in other words, the number of the suction pumps 16 and the air suppliers 17 operated.

Examples of the control device 11 include personal computers and programmable logic controllers.

The sensor 20 is, for example, a flowmeter that measures the inflow rate of waste water in the biological treatment tank 1. Such a flowmeter suitable for measuring the flow rate of waste water is, for example, a weir meter.

The number of the filtration modules 8 (suction pumps 16) operated is preferably set so as to minimize the difference between the inflow rate of waste water measured by the sensor 20 and the total rate of treated water discharged from the filtration modules 8. In other words, the control device 11 preferably performs the control by increasing or decreasing one by one the number of the suction pumps 16 (filtration blocks) operated, in accordance with an increase or decrease in the inflow rate of waste water. Stated another way, the number of the filtration modules 8 operated is preferably controlled substantially in proportion to the inflow rate of waste water, so that the total filtration area is adjusted to minimize variations in the flux. In order to prevent hunting, the increase or decrease in the number of the suction pumps 16 operated may be performed at regular intervals on the basis of the measured value of the sensor 20, and may be performed by, for example, a known control process such as PID.

For example, consider a case where, at the inflow rate of waste water being the daily average rate, the number of the filtration modules 8 operated is 10, and the optimal flux of the hollow fiber membranes 12 is 0.5 m/day. The number of the filtration modules 8 operated is preferably controlled as follows: when the inflow rate of waste water is 1.5 times the daily average rate, the number of the filtration modules 8 operated is changed to 15; when the inflow rate of waste water is 2 times the daily average rate, the number of the filtration modules 8 operated is changed to 20; and when the inflow rate of waste water is 0.5 times the daily average rate, the number of the filtration modules 8 operated is changed to 5. In this way, in spite of the variations in the inflow rate of waste water, the flux of the filtration modules 8 can be maintained at 0.5 m/day.

The control device 11 preferably operates continuously or intermittently only one or more cleaning modules 10 beneath one or more filtration modules 8 that are being operated, concurrently with the one or more filtration modules 8. In this way, to the filtration modules 8 that are stopped and do not need cleaning of the hollow fiber membranes 12, air bubbles are not supplied by the cleaning modules 10, which results in a reduction in the energy consumed by operation of the cleaning modules 10.

The control device 11 preferably selects filtration modules 8 to be operated, such that the operation periods of the filtration modules 8 become substantially the same.

### [Membrane Separation Type Activated Sludge Treatment Method]

Hereinafter, a membrane separation type activated sludge treatment method using the membrane separation type activated sludge treatment system according to an embodiment of the present invention will be described.

The membrane separation type activated sludge treatment method includes a step of performing biological treatment on waste water, and a step of performing membrane separation after the biological treatment step.

### <Biological Treatment Step>

In the biological treatment step, mainly in the biological treatment section 6 of the biological treatment tank 1, organic substances in untreated water derived from waste water are subjected to oxidative decomposition or absorptive separation caused by activated sludge.

### <Membrane Separation Step>

In the membrane separation step, the filtration modules 8 and the discharge mechanisms 9 in the membrane separation apparatus 2 are used to filter untreated water to thereby obtain treated water.

In the membrane separation step, the number of the filtration blocks (including plural filtration modules 8) operated is changed in accordance with variations in the inflow rate of waste water in the biological treatment step.

### [Advantages]

In the membrane separation type activated sludge treatment system, the number of the filtration modules 8 operated is changed in accordance with variations in the inflow rate of waste water in the biological treatment tank 1 (biological treatment step), so that, while the flux of treated water passing through the hollow fiber membranes 12 is maintained in an appropriate range, the rate of treated water discharged can be adjusted to be in balance with the inflow rate of waste water. Therefore, the membrane separation type activated sludge treatment system and the membrane separation type activated sludge treatment method using the membrane separation type activated sludge treatment system can address variations in the flow rate of waste water without using any adjusting tank.

In the membrane separation type activated sludge treatment system and the membrane separation type activated sludge treatment method, plural filtration modules 8 that are connected to the same discharge mechanism 9 to thereby share the suction system, are collectively operated or stopped as a filtration block. Thus, the control is relatively simple.

### Other Embodiments

Embodiments disclosed herein are mere examples in all respects and should be understood as placing no limitations. The scope of the present invention is not limited to the above-described features of the embodiments, but is defined by Claims. The scope of the present invention is intended to embrace all the modifications within the meaning and range of equivalency of the Claims.

The membrane separation type activated sludge treatment system may include a biological treatment tank configured to perforin biological treatment on untreated water; and a filtration tank including a filtration module and configured to filter untreated water, wherein untreated water is supplied from the biological treatment tank to the filtration tank, and sludge is returned from the filtration tank to the biological treatment tank.

The membrane separation type activated sludge treatment system may have a configuration in which discharge mechanisms are each disposed for one of filtration modules, and the filtration modules are individually operated or stopped in order to change the number of filtration modules operated.

In the membrane separation type activated sludge treatment system, the cleaning modules may include, as an air supplier, for example, a tank configured to store compressed air supplied from a compressor. The air supplier may be shared by plural cleaning modules by attaching valves for opening or closing air ducts to air headers. In particular, when the tank configured to store compressed air is used as an air supplier, sharing of the air supplier by plural cleaning modules is less likely to cause a decrease in the energy efficiency of the air supplier.

In the membrane separation type activated sludge treatment system and the membrane separation type activated sludge treatment method, the inflow rate of waste water may be measured with, for example, a liquid level gauge configured to measure the liquid level of the biological treatment tank. Specifically, from changes in the amount of untreated water stored in the biological treatment tank, the changes being measured by a liquid level gauge, and the rate of untreated water discharged from filtration modules being operated, the inflow rate of waste water in the biological treatment tank can be calculated. When a liquid level gauge is used, without calculating the inflow rate of waste water as a numerical value, the number of filtration modules operated may be controlled so as to be changed indirectly in accordance with the inflow rate of waste water. An example of such a control method is as follows: the liquid level of the biological treatment tank is measured with a liquid level gauge at regular intervals; when the liquid level is equal to or higher than a predetermined upper limit level, the number of filtration blocks (suction pumps) operated is increased by one; and when the liquid level is equal to or lower than a predetermined lower limit level, the number of filtration blocks (suction pumps) operated is decreased by one.

The membrane separation type activated sludge treatment system may include an adjusting tank configured to adjust the inflow rate of waste water. For example, installation of an adjusting tank having a relatively small capacity enables a reduction in the peak inflow rate of waste water. This enables a reduction in the number of filtration modules installed.

In the membrane separation type activated sludge treatment system and the membrane separation type activated sludge treatment method, air bubbles may be supplied from a cleaning module to a filtration module that is stopped. In this case, back washing may be performed by supplying, for example, treated water to the filtration module through its discharge-mechanism-side portion.

### REFERENCE SIGNS LIST

1 Biological treatment tank

2 Membrane separation apparatus

3 Partition part

4 Support

5 Aeration equipment

6 Biological treatment section

7 Separation section

8 Filtration module

9 Discharge mechanism

10 Cleaning module

11 Control device

12 Hollow fiber membrane

13 Upper holding member

13a Drainage nozzle

14 Lower holding member

15 Water collecting pipe

16 Suction pump

17 Air supplier

18 Air header

18a Pipe

19 Air bubble ejection port

20 Sensor

1. A membrane separation type activated sludge treatment method comprising: a step of performing biological treatment on waste water; and a step of performing membrane separation after the biological treatment step,
wherein the membrane separation step is performed with a plurality of filtration modules including a plurality of hollow fiber membranes arranged adjacent to one another and oriented in one direction and a pair of holding members fixing both ends of the plurality of hollow fiber membranes, and
a number of the filtration modules operated is changed in accordance with variations in an inflow rate of waste water in the biological treatment step.

2. The membrane separation type activated sludge treatment method according to claim 1, wherein the plurality of filtration modules are provided as a plurality of filtration blocks each including filtration modules that share a suction system, and
a number of the filtration blocks operated is changed in accordance with variations in the inflow rate of waste water in the biological treatment step.

3. The membrane separation type activated sludge treatment method according to claim 1, wherein the membrane separation step employs a plurality of cleaning modules supplying air bubbles from beneath the filtration modules, and
of the plurality of cleaning modules, only one or more cleaning modules beneath one or more filtration modules that are being operated are operated.

4. The membrane separation type activated sludge treatment method according to claim 1, wherein a daily minimum inflow rate of waste water in the biological treatment step is equal to or higher than 0.2 times a daily average inflow rate of waste water in the biological treatment step, and a daily maximum inflow rate of waste water in the biological treatment step is equal to or lower than 2 times the daily average inflow rate of waste water in the biological treatment step.

5. A membrane separation type activated sludge treatment system comprising: a tank configured to perform biological treatment on waste water, and an apparatus configured to perform membrane separation on water having been treated in the biological treatment tank,
wherein the membrane separation apparatus includes a plurality of filtration modules including a plurality of hollow fiber membranes arranged adjacent to one another and oriented in one direction and a pair of holding members fixing both ends of the plurality of hollow fiber membranes, and
the membrane separation apparatus comprises a device configured to change a number of the filtration modules operated, in accordance with variations in an inflow rate of waste water in the biological treatment tank.

6. The membrane separation type activated sludge treatment system according to claim 5, not comprising a tank configured to adjust the inflow rate of waste water in the biological treatment tank.
